(19) United States
(12) Patent Application Publication
(10) Pub. No.: US 2014/0006265 A1
(43) Pub. Date: Jan. 2, 2014

(54) Mobile Terminal, Software Sharing System and Sharing Method

(71) Applicant: Dawei Ye, Huizhou (CN)

(72) Inventor: Dawei Ye, Huizhou (CN)

(73) Assignee: Huizhou Tcl Mobile Communication Co., Ltd, Huizhou (CN)

(21) Appl. No.: 14/006,299

(22) PCT Filed: Jun. 20, 2012
(86) PCT No.: PCT/CN12/77237

§ 371 Date: Sep. 19, 2013

(30) Foreign Application Priority Data
Jul. 11, 2011 (CN) 201110193170.2

(51) Int. Cl. G06Q 20/12

(52) U.S. Cl. CPC G06Q 20/12
USPC 705/39

(57) ABSTRACT

A mobile terminal may include a far-end communication module for downloading shared software from a remote server; a software management module for acquiring a software sharing request; and a near-end communication module for sending the shared software to another mobile terminal according to the software sharing request by way of short range transmission. A software sharing system and a sharing method may be included on the mobile terminal. The present invention may achieve fast sharing of software between mobile terminals.

### TECHNICAL FIELD

The present invention relates to the mobile terminal field and, in particular, relates to a mobile terminal, a software sharing system and a sharing method.

### BACKGROUND ART

A digital application store is an important channel for release of digital products. A user of a mobile terminal must perform payment to complete a transaction in a digital application store before downloading software from the digital application store. The developer of the software and the digital application store may share the revenue.

The digital application store may include an App Store® of Apple®, an Android Market™ of Google®, a Market Place of Microsoft® and the Wholesale Applications Community (WAC)® alliance of operators and so on, which can be used for providing a sharing server to users to download software. Generally, users of the mobile terminals have to pay a fee first in the digital application store before downloading, installing and running the software. Installing and running the software is usually conducted under the supervision of a management program provided by the digital application store; that is to say, the digital application store will strictly control a distribution process of the software, and the software in the digital application store is not allowed to be transmitted to or installed on other terminals after being downloaded. The purpose of the digital application store forbidding duplicates of software among different mobile terminals is to prevent the free transmission of paid-for software among other various users who have not paid after the software is downloaded by a user, which can protect the software against piracy.

At the same time, however, this brings inconveniences to users. For example, when a user finds that there is nice software in a mobile terminal of another user and wants to buy and use it too, the user has to get on line and purchase the software from the digital application store to download and use the software. The data sizes of software are now becoming larger and larger, and some game software can have a data size of dozens of megabytes. Using a data communication network provided by the operator to download the software with a large data size will take a large amount of network traffic and cost a lot, and so the users will like to download the software only when there is a wifi connection available. When a user is outside, where there is only a data communication network available, the downloading speed is slow and the cost for data traffic is high, especially abroad, where the roaming charge is much more expensive. Moreover, in some countries and regions, the internet construction is still relatively backwards, so it is more difficult for the users in these countries and regions to download software through a data communication network.

Therefore, a method of achieving fast sharing of software between mobile terminals is an issue which needs to be solved.

### SUMMARY OF THE INVENTION

The present invention mainly solves the technical problem that software can not be shared and used quickly between mobile terminals, and provides a mobile terminal, a software sharing system and a sharing method, which can achieve fast sharing of software between mobile terminals.

A technical solution employed by the present invention to solve the above mentioned technical problem is providing a software sharing method which comprises the steps of: downloading shared software from a remote server; acquiring a software sharing request; communicating with the remote server to pay a required fee for transmitting the shared software, and acquiring a software transmitting authorization for the shared software issued by the remote server after the remote server confirms the receipt of the fee; sending the shared software to an external device according to the software sharing request and the software transmitting authorization by way of a short range transmission.

As an improvement of the method described above, the method may further comprise the steps of: demonstrating to-be-shared software to a user; and acquiring the software sharing request generated after the user chooses the shared software from the to-be-shared software.

Another technical solution employed in the present invention to solve above mentioned technical problem is providing a mobile terminal, which comprises: a far-end communication module for downloading shared software from a remote server; a software management module for acquiring a software sharing request; and a near-end communication module for sending the shared software to another mobile terminal according to the software sharing request by way of short range transmission.

As an improvement for the mobile terminal described above, upon the acquirement of the software sharing request, the software management module further commands the far-end communication module to acquire a software transmitting authorization from the remote server, and commands the near-end communication module to send the shared software according to the software sharing request and the software transmitting authorization by way of a short range transmission.

As an improvement of the mobile terminal described above, the software management module utilizes the far-end communication module to communicate with the remote server to pay the fee for transmitting the shared software, and the remote server issues the software transmitting authorization to the far-end communication module after confirming the receipt of the fee.

As an improvement of above-described mobile terminal, the mobile terminal further comprises a user interface module, which demonstrates to-be-shared software for a user. The user chooses the shared software from the to-be-shared software via the user interface module to generate the software sharing request.

As a further improvement of the above-described mobile terminal, the near-end communication module acquires the software sharing request from said another mobile terminal.

Another technical solution employed in the present invention to solve above-described technical problem is providing a software sharing system, which comprises: a remote server on which a plurality of shared software are set for users to download; a first mobile terminal comprising a first far-end communication module, a first near-end communication module and a first software management module; a second mobile terminal comprising a second far-end communication module, a second near-end communication module and a second software management module, wherein, the first far-end communication module downloads the shared software from the remote server, the first near-end communication module acquires a software sharing request, and the first software management module commands the first near-end communication to send the shared software to the second near-end communication module according to the software sharing request by way of a short range transmission.

As an improvement of the software sharing system described above, when the software sharing request is obtained, the first software management module further commands the first far-end communication module to acquire a software transmitting authorization from the remote server, and commands the first near-end communication to send the shared software to the second near-end communication module by way of short range transmission according to the software sharing request and the software transmitting authorization. The first software management module utilizes the first far-end communication module to communicate with the remote server to pay the fee for transmitting the shared software. The remote server issues the software transmitting authorization to the first far-end communication module after confirming the receipt of the fee.

As an improvement of the software sharing system described above, upon acquiring the software sharing request, the first software management module further commands the first near-end communication module to acquire software transmission confirming information from the second near-end communication module and commands the first near-end communication to send the shared software to the second near-end communication module by way of short range transmission according to the software sharing request and the software transmission confirming information. The second software management module utilizes the second far-end communication module to communicate with the remote server so as to pay the fee for transmitting the shared software. The remote server provides the software transmitting authorization to the second far-end communication module after confirming the receipt of the fee, and the second software management module generates the software transmission confirming information based on the software transmitting authorization.

The beneficial effects of the present invention are: the invention differs from the existing art, the present invention downloads shared software from a server through a far-end communication module, and acquires a software sharing request via a software management module and finally sends the shared software to another mobile terminal through a near-end communication module by way of short range transmission. The mobile terminal of the present invention can achieve software transmission within a short distance, especially for the paid-for software, can reduce the downloading procedures of high traffic from the server, and can lower the high traffic cost.

### DESCRIPTION OF THE DRAWINGS

FIG. 1 is a schematic diagram showing a plurality of function modules of a software sharing system according to the present invention;

FIG. 2 is a schematic diagram showing the function modules in an exemplary embodiment for a mobile terminal of the software sharing system shown in FIG. 1;

FIG. 3 is a schematic diagram showing a working principle of the software sharing system shown in FIG. 1; and

FIG. 4 is a schematic diagram showing a working process of a software sharing method of the software sharing system shown in FIG. 1.

### DETAILED DESCRIPTION OF EMBODIMENTS

FIG. 1 is a schematic diagram showing the function modules of a software sharing system according to the present invention.

In an embodiment of the present invention, the software sharing system comprises: a remote server 10, on which a plurality of shared software are set for users to download; a first mobile terminal 1 comprising a first far-end communication module 11, a first near-end communication module 13 and a first software management module 12; a second mobile terminal 2 comprising a second far-end communication module 21, a second near-end communication module 23 and a second software management module 22, wherein the first far-end communication module 11 downloads the shared software from the remote server 10, the first near-end communication module 13 acquires a software sharing request, and the first software management module 12 commands the first near-end communication module 13 to send the shared software to the second near-end communication module 23 according to the software sharing request by way of short range transmission.

In an embodiment of the present invention, the first mobile terminal 1 can provide a first user interface module (not shown in the Figure) to demonstrate to-be-shared software for a user, and the user chooses the shared software from the to-be-shared software via the first user interface module to generate the software sharing request. The first user interface module can be implemented by a display screen, a keyboard or a touch screen of a mobile terminal, and by the corresponding control code which can indicate the information of the to-be-shared software on a display screen and choose the shared software according to the input of the user on a keyboard or a touch screen.

In addition to using the above mentioned method to acquire a software sharing request, in other embodiments of the present invention the software sharing request can also be acquired by the first near-end communication module 13 from the second near-end communication module 23.

Therefore, after the first mobile terminal 1 obtains the shared software from the remote server 10, the shared software can be transmitted to the second mobile terminal 2 according to the acquired software sharing request by way of short range transmission, and a fast transmission of software between mobile terminals can be achieved.

However, if the shared software is not a free open source software, then infringement on the developers of the software may be caused. Therefore, in another embodiment described below of the present invention, an authentication mechanism is added into the above described embodiment to ensure that the non-open source software will not be transmitted illegally.

In another embodiment of the present invention, when the first software management module 12 acquires a software sharing request, it can further ommand the first far-end module 11 to acquire a software transmitting authorization from the remote server 10 and make the first near-end communication module 13 send the shared software to the second near-end communication module 23 according to the software sharing request and the software transmitting authorization by way of short range transmission. As previously mentioned, a user can trigger a software sharing request via ways such as using an interface, and can use the second mobile terminal 2 to initiate the software sharing request to the first mobile terminal.

In an embodiment, the method for acquiring a software transmitting authorization includes:

Approach 1. On the acquirement of the software sharing request, the first software management module 12 further commands the first near-end communication module 13 to acquire a software transmission confirming information from the second near-end communication module 23 and commands the first near-end communication module 13 to send the shared software to the second near-end communication module 23 by way of short range transmission according to the software sharing request and the software transmission confirming information. The generation of the software transmission confirming information is as follows: the second software management module 22 utilizes the second far-end communication module 21 to communicate with the remote server 10 so as to pay the fee for distributing the shared software, the remote server 10 issues the software transmitting authorization to the second far-end communication module 21 after confirming the receipt of the fee, and the second software management module generates the software transmission confirming information based on the software transmitting authorization;

Approach 2. On the acquirement of the software sharing request, the first software management module 12 further causes the first far-end communication module 11 to acquire a software distribution authorization from the remote server 10, and commands the first near-end communication module 13 to send the shared software to the second near-end communication module 23 by way of short range transmission according to the software sharing request and the software transmitting authorization. The first software management module 12 utilizes the first far-end communication module 11 to communicate with the remote server 10 to pay the fee for distributing the shared software. The remote server 10 issues the software transmitting authorization to the first far-end communication module 11 after confirming the receipt of the fee.

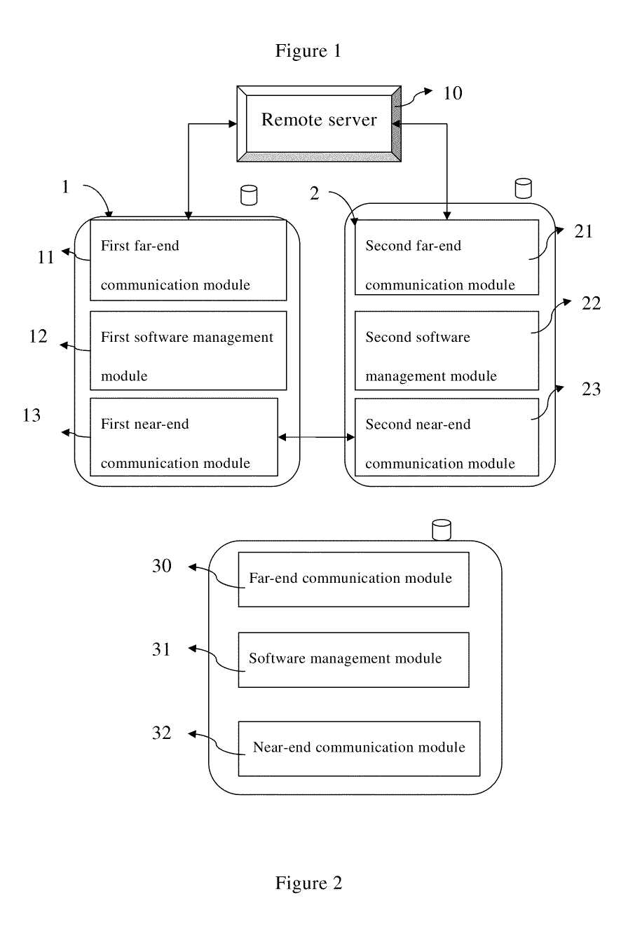

FIG. 2 is a schematic diagram showing the function modules in an embodiment of a mobile terminal for the software sharing system shown in FIG. 1;

In another embodiment of the present invention, the mobile terminal comprises a far-end communication module 30 for downloading shared software from the remote server 10. In the present invention, the remote server refers to a digital application store, such as an App Store® of Apple®, the Android Market™ of Google®, the Market Place of Microsoft® and the WAC® alliance of the operators, which is a shared server used for providing software for users to download; a software management module 31 for downloading, installing and running the software remotely, wherein the software management module is used for acquiring a software sharing request; and a near-end communication module 32 for a connection and transmission between mobile terminals, such that the near-end communication module 32 sends the shared software to another mobile terminal according to the software sharing request by way of short distance transmission.

In an embodiment, the far-end communication module 30 provides a far-end communication API (Application Program Interface), and the far-end communication API is used for establishing a connection to the remote server 10.

In a further embodiment, the software management module 31 is realized in a way of program function, that is it exists in the mobile terminal in a way of program function. Generally the thread management mechanism of the software management module 31 is provided and built by the mobile terminal system to achieve switches between threads. For example, a function Thread_Resume ( ) includes resuming an execution of a thread, and a function Thread_Suspend ( ) suspends the execution of a thread. The software management module 31 can call the APIs of the mobile terminal system to execute various communication operations, such as Bluetooth® API (near-end communication) and GPRS API (Global Positioning System Application Program Interface, far-end communication).

In a further embodiment, the near-end communication module 32 can be implemented with Bluetooth® chips, near field communication chips or USB transmission control chips. The near field communication (NFC), also called short range wireless communication, is a high frequency wireless communication technology for a short distance, allowing contactless point-to-point data transmission and data exchanges within 10 cm (3.9 inches) between electronic devices. NFC technology traces its roots back to contactless radio-frequency identification, and the near field communication has two read modes, active read mode and passive read mode. Through the near field communication technology, the present invention can achieve the connection and transmission of software having large data size between mobile terminals. In addition, the mobile terminal of the present invention can connect to a computer, a PDA (personal digital assistant) and a hands-free receiver via Bluetooth®. Besides the above mentioned two connection methods, the present invention can also include other radio-frequency short range connection communications.

In a further embodiment, upon the acquirement of the software sharing request, the software management module 31 further commands the far-end communication module 30 to acquire a software transmitting authorization from the remote server 10, and causes the near-end communication module 32 to send the shared software by way of short range transmission according to the software sharing request and the software transmitting authorization.

In a further embodiment, the software management module 31 utilizes the far-end communication module 30 to communicate with the remote server 10 to pay the fee for distributing the shared software, and the remote server 10 provides a software transmitting authorization to the far-end communication module 30 after confirming the receipt of the fee. The mobile terminal can perform payment directly via the far-end communication module 30 to acquire the software transmitting authorization. The software distribution authorization can be acquired by the near-end communication module 32 from another mobile terminal.

In a further embodiment, the mobile terminal further comprises a user interface module (not shown in the Figure). The user interface module demonstrates to-be-shared software for a user, and the user chooses the shared software from the to-be-shared software via the user interface module to generate a sharing request of the software. As mentioned previously, the mobile terminal can acquire the software sharing request from another mobile terminal through the near-end communication module 32.

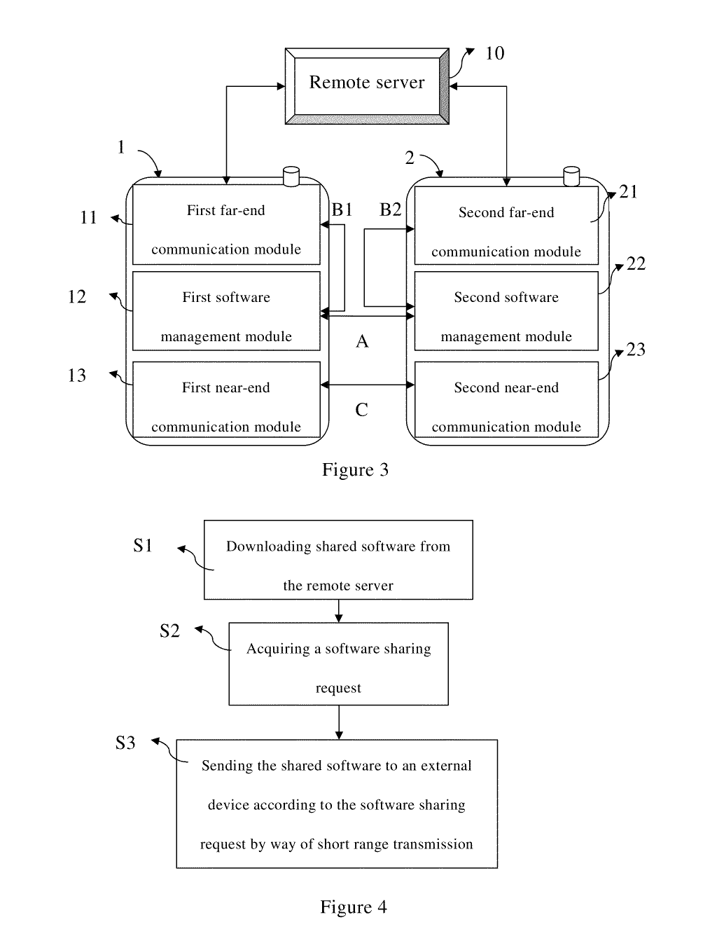

FIG. 3 is a schematic diagram showing the working principle of the software sharing system shown in FIG. 1. FIG. 4 is a schematic diagram showing the working process of a software sharing method for the software sharing system shown in FIG. 1.

The working principle of the software sharing system comprises:
procedure A, in which the first software management module 12 and the second software management module 22 build a connection between each other and perform the negotiation about the software transmission confirming information, such as which mobile terminal should be chosen to pay the cost for the shared software;
procedure B1, in which, if it is the first mobile terminal 1 that should pay the cost, then the first software management module 12 notifies the first far-end communication module 11 to connect with the remote server 10 to perform the payment;
procedure B2, in which, if it is the second mobile terminal 2 that should pay the fee, then the second software management module 22 notifies the second far-end communication module 21 to connect with the remote server 10 to perform the payment;
procedure C, in which the first near-end communication module 13 and the second near-end communication module 23 perform the software sharing by the building of communication link between them.

The above implemented procedures of the working principle are only for a brief description of the software sharing system of the present invention. The specific implemented procedure can include various ways, and the present invention does not limit the detailed process.

FIG. 4 is a schematic diagram showing the working process of a software sharing method of the software sharing system shown in FIG. 1, wherein, the software sharing method comprises the steps of:
Step S1: downloading shard software from a remote server;
Step S2: acquiring a software sharing request; and
Step S3: sending the shared software to an external device by way of short range transmission according to the software sharing request.

In an embodiment, the Step S2 can further comprise: after the software sharing request is acquired, obtaining a software transmitting authorization according to the software sharing request, the step S3 can further comprise: sending the shared software to an external device by way of short range transmission according to the software sharing request and the software transmitting authorization.

In an embodiment, the external device is another mobile terminal.

In an embodiment, the far-end communication module of the mobile terminal downloads the shared software from the remote server, and the software includes free sharing software and paid-for sharing software.

In an embodiment, the software sharing request can be triggered by the user interface module of the mobile terminal, and it can also be initiated by the external device initiatively to the mobile terminal.

In an embodiment, a software transmitting authorization can be acquired for the shared software from the remote server, and the software transmitting authorization can be acquired from the remote server by performing the payment via the far-end communication module of the mobile terminal or be acquired by the software transmission confirming information provided by the external device.

It should be noted that in all embodiments of the present invention, the short range transmission includes but is not limited to: Near Field Communication, Bluetooth®, USB or Wireless Local Area Network (WLAN).

The mobile terminal, the software sharing system and the sharing method thereof of the present invention download the shared software from a remote server through a far-end communication module, and send the shared software to the mobile terminal of the demander by way of short range transmission. The present invention achieves fast sharing of the shared software, reduces the data traffic for downloading the software from the remote server and reduces the high cost.

Described above are embodiments of the present invention, and rather than limit the scope of the present invention, all the equivalent structure or process changes made according to the accompanied drawings and description of the present invention, or direct or indirect application in other relative technical fields, should fall into the protective scope of the present invention.

1. A software sharing method, comprising:
downloading shared software from a remote server;
acquiring a software sharing request;
communicating with the remote server to pay a required fee for transmitting the shared software, and to acquire a software transmitting authorization issued by the remote server after the remote server confirms a receipt of the fee; and
sending the shared software to an external device according to the software sharing request and the software transmitting authorization by way of short range transmission.

2. The method of claim 1, further comprising:
demonstrating to-be-shared software to a user; and
acquiring the software sharing request generated after the user chooses the shared software from the to-be-shared software.

3. A mobile terminal, comprising:
a far-end communication module configured to download shared software from a remote server;
a software management module configured to acquire a software sharing request; and
a near-end communication module configured to send the shared software to another mobile terminal according to the software sharing request by way of a short range transmission.

4. The mobile terminal of claim 3, wherein when acquiring the software sharing request, the software management module is configured to command the far-end communication module to acquire a software transmitting authorization from the remote server, and is configured to command the near-end communication module to send the shared software by way of the short range transmission according to the software sharing request and a software transmitting authorization.

5. The mobile terminal of claim 4, wherein the software management module is configured to communication with the remote server by utilizing the far-end communication module to pay a required fee for transmitting the shared software, and the remote server is configured to issue the software transmitting authorization to the far-end communication module after confirming a receipt of a fee.

6. The mobile terminal of claim 3, further comprising:
a user interface module configured to demonstrate to-be-shared software to a user.

7. The mobile terminal of claim 3, wherein the near-end communication module is configured to acquire the software sharing request from said another mobile terminal.

8. A software sharing system, comprising:
a remote server on which a plurality of software are arranged for a plurality of users to download;
a first mobile terminal comprising a first far-end communication module, a first near-end communication module and a first software management module;
a second mobile terminal comprising a second far-end communication module, a second near-end communication module and a second software management module,
wherein the first far-end communication module is configured to download shared software from the remote server, the first near-end communication module is configured to acquire a software sharing request, and the first software management module is configured to command the first near-end communication to send the shared software to the second near-end communication module by way of short range transmission according to the software sharing request.

9. The software sharing system of claim 8,
wherein when acquiring the software sharing request, the first software management module is configured to command the first far-end communication module to acquire a software transmitting authorization from the remote server, and is configured to command the first near-end communication module to send the shared software to the second near-end communication module by way of the short range transmission according to the software sharing request and the software transmitting authorization, and
wherein the first software management module is configured to communicate with the remote server by utilizing the first far-end communication module to pay a required fee for transmitting the shared software, the remote server is configured to issue the software transmitting authorization to the first far-end communication module after confirming the receipt of the fee.

10. The software sharing system of claim 9, wherein when acquiring the software sharing request, the first software management module is configured to command the first near-end communication module to acquire a software transmission confirming information from the second near-end communication module, and is configured to command the first near-end communication module to send the shared software to the second near-end communication module by way of short range transmission according to the software sharing request and the software transmission confirming information,
wherein the second software management module is configured to communicate with the remote server by utilizing the second far-end communication module to pay a required fee for transmitting the shared software, and the remote server is configured to issue the software transmitting authorization to the second far-end communication module after confirming the receipt of the fee, and the second software management module is configured to generate the software transmission confirming information based on the software transmitting authorization.

11. The method of claim 1, wherein the remote server is configured to refer a user to a commercial digital store.

12. The method of claim 1, wherein the short range transmission is wireless.

13. The method of claim 1, wherein the short range transmission has an active and a passive mode.

14. The method of claim 1, wherein the software sharing request is acquired from a mobile terminal.

15. The method of claim 14, wherein the software sharing request is acquired from a first mobile terminal, which has received the software sharing request from a second mobile terminal.

16. The mobile terminal of claim 3, wherein the remote server is configured to refer a user to a commercial digital store.

17. The mobile terminal of claim 3, wherein the short range transmission is wireless.

18. The mobile terminal of claim 3, wherein the short range transmission has an active and a passive mode.

19. The software sharing system of claim 8, wherein the remote server is configured to refer a user to a commercial digital store.

20. The software sharing system of claim 8, wherein the short range transmission is wireless.
